(19) United States
(12) Patent Application Publication
(10) Pub. No.: US 2006/0285999 A1
(43) Pub. Date: Dec. 21, 2006

(54) Apparatus and method for coupling microfluidic systems with electrospray ionization mass spectrometry utilizing a hydrodynamic flow restrictor

(75) Inventor: Aaron T. Timperman, Morgantown, WV (US)

Correspondence Address: SONNENSCHEIN NATH & ROSENTHAL LLP;FOR PAULA EVANS, P.O. BOX 061080, WACKER DRIVE STATION, SEARS TOWER, CHICAGO, IL, 60606-1080, US

(73) Assignee: West Virginia University Research Corporation

(21) Appl. No.: 11/157,545

(22) Filed: Jun. 21, 2005

(51) Int. Cl. B01L 3/00

(52) U.S. Cl. 422/100

(57) ABSTRACT

A microfluidic device is disclosed wherein a hydrodynamic flow restrictor is positioned in a main channel; a make-up flow channel engages the main channel at a position between the hydrodynamic flow restrictor and an output channel. The hydrodynamic flow restrictor substantially negates a hydrodynamic backpressure in the main channel to the extent that low electroosmotic flow may be utilized in the main channel. Further, a method is disclosed wherein a sample is delivered to the main channel and low EOF drives the sample through the main channel. The method comprises positioning a hydrodynamic flow restrictor in the main channel and delivering a make-up solution via hydrodynamic flow to the main channel at a position between a hydrodynamic flow restrictor and the output channel. The hydrodynamic flow restrictor substantially negates a hydrodynamic backpressure in the main channel to the extent that low electroosmotic flow may be utilized in the main channel.

### GOVERNMENT SUPPORT

The invention was supported, in whole or in part, by Grant No. RR16440 from the National Institute of Health. The Government has certain rights in the invention.

### RELATED APPLICATIONS

None.

### FIELD OF THE INVENTION

The invention relates to microfluidic devices. More specifically, the invention discloses an apparatus and method for coupling microfluidic systems with electrospray ionization mass spectrometry utilizing a combination of hydrodynamic flow and electroosmotic flow.

### BACKGROUND OF THE INVENTION

Microfluidic analytical systems have been engineered for sample preparation, solid phase extraction, tryptic digestions and separations of biological samples. Massive parallelism, shorter analysis time, increased separation efficiencies, higher sensitivities and reduced waste generation can be achieved with these devices. Microfluidic devices are characterized by their zero dead volume intersections and small channels, having depths and widths ranging from a few microns to a few hundred microns. These intersections allow for fabrication of microfluidic networks that can be used to create microfluidic systems for integrating sample handling, analysis , and other processes.

Mass spectrometry (MS) is one of the most widely used instrumental methods for molecular characterization, because of its ability to provide detailed structural information and its low limits of detection. Of the ion sources for MS, electrospray ionization (ESI) is best suited for the generation of molecular ions from the solution phase, and consequently ESI is the method of choice for combining on-line separations with the MS. ESI-MS is concentration sensitive, and consequently the best LODs are obtained for a given analyte mass by reducing the volume in which the sample is contained. Therefore, coupling microfluidic systems for sample handling and separation with ESI/MS can greatly improve performance for trace analyses.

However, development of a robust and flexible interface for microfluidic capillary electrophoresis and ESI is not as simple as it can appear initially. Complications arise because the flowrate at the ESI tip is largely determined by the orifice internal diameter (ID), and the orifice ID greatly influences the resistance to hydrodynamic flow. Increasing the spray tip orifice ID to reduce the resistance to flow also requires higher flowrates that can be difficult to produce electroosmotically. As a result of the numerous competing processes in a CE/MS interface, many types of microfluidic-ESI-MS interfaces have been developed, and they can generally be classified in three different categories: sheathless, sheath flow, and liquid junction. The sheathless configuration utilizes an electrode immersed in solution of a reservoir on the microfluidic chip, to apply both the CE and the electrospray voltage. Alternatively, the electrospray voltage can be applied via a metal (e.g., gold or silver) coated spray tip. The sheath flow interface configuration utilizes a transfer capillary to transport the sample to a sheath flow interface where the electrospray voltage is applied and the make-up solution introduced. Lastly, a number of microfluidic/ESI-MS interfaces have used a liquid junction for the application of the electrospray voltage as well as make-up flow solution addition. Liquid junctions have been constructed on-chip and off-chip. A major limitation of these interfaces is that high EOF is required for these types of devices to function properly.

In general, microfluidic systems are generally driven by electrokinetic or hydrodynamic flow, because it is difficult to combine the two methods of mass transport in one system. More specifically, it is difficult to maintain low EOF in the main separation channel while supplying a solution (i.e., a make-up solution) to the separation channel via hydrodynamic flow. The ability to use low EOF separations is critical in many applications because coatings that are required to minimize analyte adsorption to the capillary walls, such as polyethylene glycol coatings for protein separations, also minimize EOF. Additionally, the low EOF increases the separation time, which increases the resolution in capillary electrophoretic separations.

As such, there is a need in the art for an apparatus and method for coupling a microfluidic device to a mass spectrometer wherein electroosmotic flow may be used in combination with hydrodynamic flow to optimize processing, analysis and detection of a sample.

### SUMMARY OF THE INVENTION

In an embodiment, a microfluidic device is disclosed which comprises a substrate having an input channel, an output channel and a main channel engaging the input channel to the output channel. In an embodiment, the device comprises a hydrodynamic flow restrictor positioned in the main channel; further, the device comprises a make-up flow channel engaging the main channel at a position between the hydrodynamic flow restrictor and the output channel. In an embodiment, the hydrodynamic flow restrictor substantially negates a hydrodynamic backpressure in the main channel to the extent that low electroosmotic flow may be utilized in the main channel.

In an embodiment, a microfluidic device is disclosed which is capable of utilizing a hydrodynamic flow in combination with an electroosmotic flow to deliver a sample to a mass spectrometer. In an embodiment, the device comprises a substrate having an input channel and an output channel. In an embodiment, a main channel engages the input channel to the output channel; further, an embodiment comprises a hydrodynamic flow restrictor positioned in the main channel and a make-up flow channel engaging the main channel at a position between the hydrodynamic flow restrictor and the output channel. In an embodiment, the main channel comprises an uncharged coating to produce a low EOF in the main channel.

In an embodiment, a method is disclosed for utilizing a hydrodynamic flow in conjunction with an electroosmotic flow in order to deliver a sample to a mass spectrometer. In an embodiment, the method comprises providing a substrate having an input channel and an output channel, wherein a main channel engages the input channel to the output channel. In an embodiment, the method comprises delivering a sample to the input channel wherein a low electoosmotic force drives the sample through the main channel and towards the output channel. In an embodiment, the method comprises positioning a hydrodynamic flow restrictor in the main channel and delivering a make-up solution via hydrodynamic flow to the main channel at a position between the hydrodynamic flow restrictor and the output channel. In an embodiment, the hydrodynamic flow restrictor substantially negates a hydrodynamic backpressure in the main channel to the extent that low electroosmotic flow may be utilized in the main channel.

### BRIEF DESCRIPTION OF THE DRAWINGS

The present invention will be further explained with reference to the attached drawings, wherein like structures are referred to by like numerals throughout the several views. The drawings shown are not necessarily to scale, with emphasis instead generally being placed upon illustrating the principles of the present invention.

FIG. 1 shows an embodiment wherein a hydrodynamic flow restrictor is positioned in the main channel of a microfluidic device.

FIG. 2 shows an embodiment wherein additional hydrodynamic flow restrictors are positioned in additional channels of the microfluidic device.

FIG. 3 shows a top view of an embodiment of a hydrodynamic flow restrictor located in the main channel of the microfluidic device.

FIG. 4 shows a cross-sectional view of an embodiment of the main channel as seen along segment A-A as shown in FIG. 3.

FIG. 5 shows a cross-sectional view of an embodiment of the main channel as seen along segment B-B as shown in FIG. 3.

FIGS. 6A-D shows various embodiments of a hydrodynamic flow restrictor.

FIG. 7 shows an embodiment of a hydrodynamic flow restrictor incorporated into a microfluidic chip/ESI-MS interface.

FIG. 8A shows a microfluidic device utilized for band broadening studies. FIG. 8B shows CCD camera images of a 1 μM rhodamine B sample plug from the time the plug was injected and at different points along the separation channel. FIG. 8C shows a corresponding graph of band profiles of a sample plug just before the hydrodynamic flow restrictor and after the hydrodynamic flow restrictor.

FIG. 9 shows a total ion chromatogram of the solvent/buffer background. The chromatogram illustrates the stability of the electrospray.

FIG. 10 shows various images of flow profiles.

While the above-identified drawings set forth preferred embodiments of the present invention, other embodiments of the present invention are also contemplated, as noted in the discussion. This disclosure presents illustrative embodiments of the present invention by way of representation and not limitation. Numerous other modifications and embodiments can be devised by those skilled in the art which fall within the scope and sprit of the principles of the present invention.

### DETAILED DESCRIPTION

In an embodiment, the microchip-ESI-MS interface integrates the introduction of a sheath solution and application of the electrospray voltage onto the microfluidic device. In an embodiment, the interface design substantially prevents back-flow of solution into the separation channel and allows use of an electrophoretic system with low EOF. The use of low EOF systems is particularly important for proteins, because coatings that minimize protein absorption also minimize EOF. In an embodiment, the apparatus and method can decouple the ESI and capillary electrophoresis (“CE”) voltages to enable upstream fluidic control for sample handling while samples are infused into the mass spectrometer.

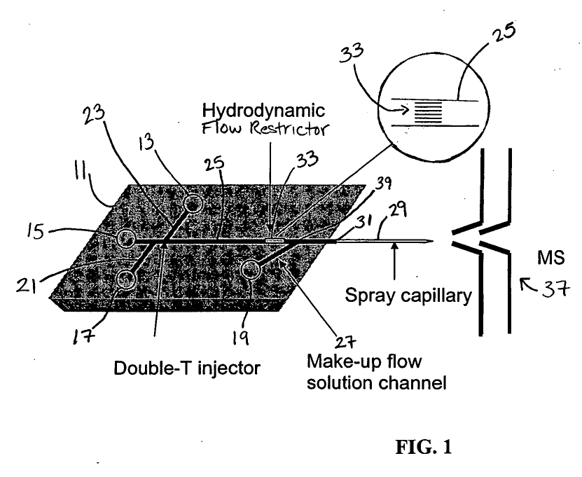

FIG. 1 shows an embodiment wherein a microfluidic device 11 is engaged to a mass spectrometer 37. The microfluidic device 11 comprises a main channel 25 wherein the main channel engages an input channel 21 and a waste channel 23. In an embodiment, a high voltage electrode 15 is positioned adjacent to the input channel 21. In an embodiment, the high voltage electrode 15 provides a force to move a sample from the main channel 25 to the mass spectrometer 37. In an embodiment, the input channel 21 is engaged to an input reservoir 17 and the waste channel 23 is engaged to a waste reservoir 13. Those skilled in the art will recognize that engaging additional channels to the main channel is within the spirit and scope of the present invention.

In an embodiment, capillary electrophoresis of a sample occurs in the main channel 25 of the microfluidic device 11. The separated analytes continue down the main channel 25 of the microfluidic device 11 and into a spray capillary 29. In an embodiment, the separated analytes are then delivered to the mass spectrometer 37 via electrospray ionization.

In an embodiment, the main channel 25 of the microfluidic device 11 engages a make-up flow channel 27. The make-up flow channel 27 is engaged to a make-up flow reservoir 19. In an embodiment, an electrode is placed in the make-up flow reservoir. Those skilled in the art will recognize that the microfluidic device may comprise a plurality of make-up flow channels and be within the spirit and scope of the present invention.

The introduction of make-up flow to a microfluidic device 11 of the present invention serves various purposes. First, make-up flow may be added to change the pH of the solution in the main channel. For example, in an embodiment, the use of make-up flow allows for high pH (about a pH of 8) tryptic digestions upstream and use of a low pH make-up solution to lower the pH of the digest, enabling the use of the more sensitive positive ion mode MS detection of the digest. Further, by positioning an electrode in the make-up flow reservoir 19, an embodiment provides an apparatus and method that can decouple the ESI and capillary electrophoresis (“CE”) voltages to enable upstream fluidic control for sample handling while samples are infused into the mass spectrometer 37, a major difference form the majority of microchip-MS interface designs which are solely dedicated to infusion of samples. In an embodiment, a make-up flow is delivered to the main channel 25 to prevent samples from being drawn from the main channel 25 into the make-up flow channel 27 due to the presence of the electrode in the make-up flow reservoir 19. Those skilled in the art will recognize various make-up flow solutions are within the spirit and scope of the present invention.

In an embodiment, the make-up flow enters the main channel 25 and is delivered downstream towards the mass spectrometer 37. In an embodiment, a hydrodynamic flow restrictor 33 is positioned in the main channel 25 (upstream of the intersection 39 of the main channel 25 and the make-up flow channel 27). The hydrodynamic flow restrictor 33 of the present invention prevents the make-up flow solution from traveling upstream towards the input channel 21.

In an embodiment, the hydrodynamic flow restrictor 33 is a plurality of deep, narrow channels which are created through laser etching. In an embodiment, the deep narrow channels are about 10 μm. In an embodiment, the cross-sectional area of the plurality of channels 33 is approximately equal to the cross sectional area of the main channel 25. Maintaining a cross-sectional are allows for a minimal increase in voltage to achieve the desired flow rate through the narrow channels 33 and back into the main channel 25. Those skilled in the art will recognize that various dimensions of the plurality of deep, narrow channels 33 is within the spirit and scope of the present invention.

In an embodiment, the hydrodynamic flow restrictor 33 comprises a sol-gel material. In an embodiment, the hydrodynamic flow restrictor 33 comprises a weir. In an embodiment, the hydrodynamic flow restrictor comprises a frit. Those skilled in the art will recognize that various hydrodynamic flow restrictors are within the spirit and scope of the present invention.

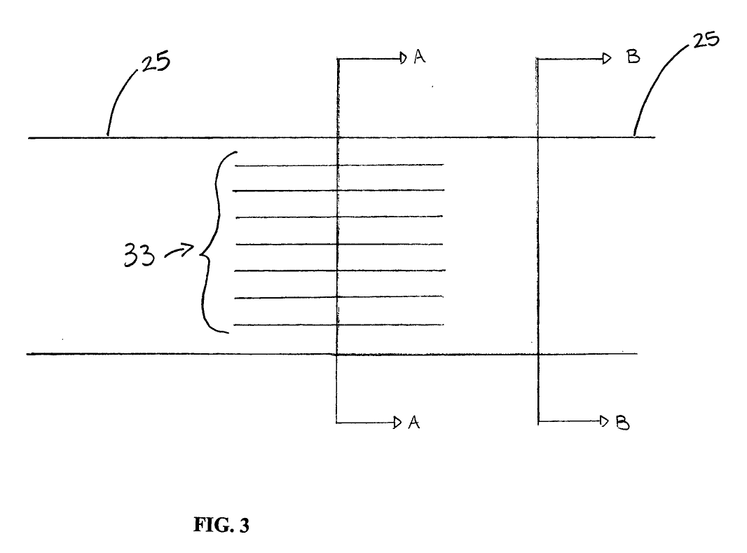

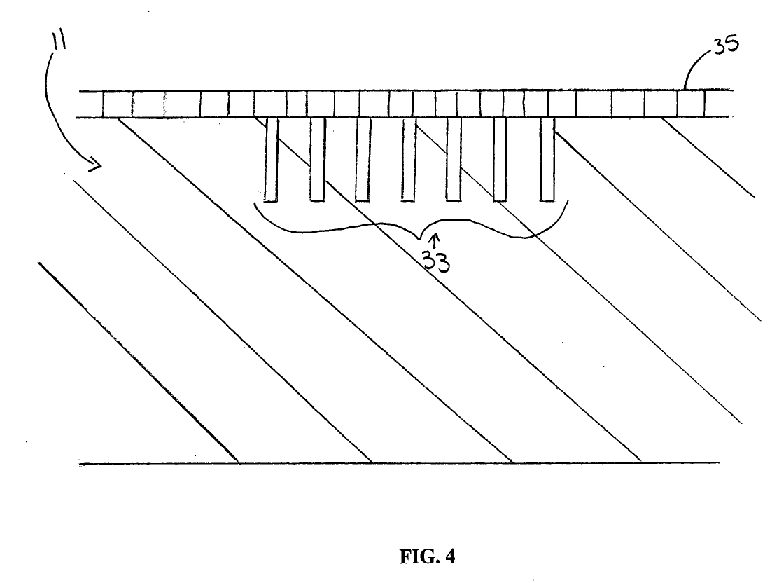

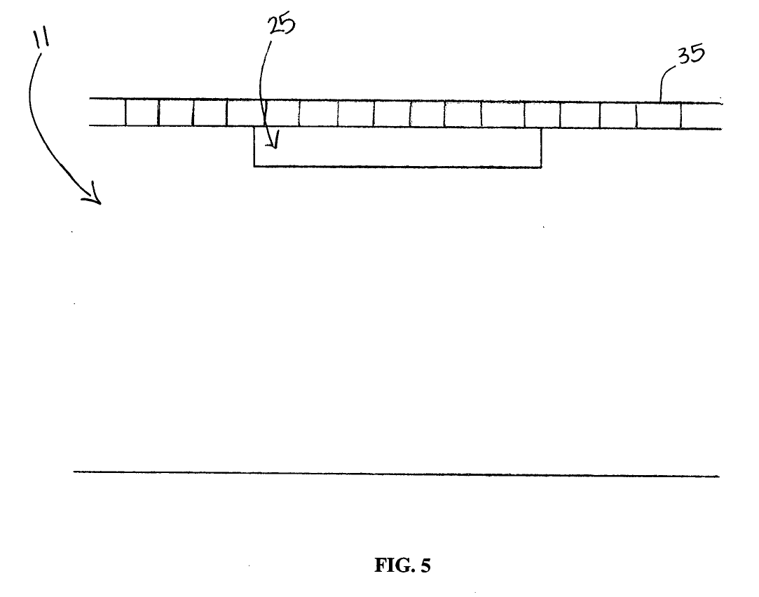

FIG. 3 shows a top view of an embodiment of a main channel 25 wherein the hydrodymic flow restrictor 33 comprises a plurality of deep, narrow channels. FIG. 4 shows a cross section of the plurality deep, narrow channels 33 as seen along segment A-A of FIG. 3. FIG. 4 additionally displays a cover plate 35 which may engage the microfluidic device. FIG. 5 shows a cross section of the main channel 25 as seen along segment B-B of FIG. 3. FIG. 5 additionally displays the cover plate 35 which may engage the microfluidic device 11.

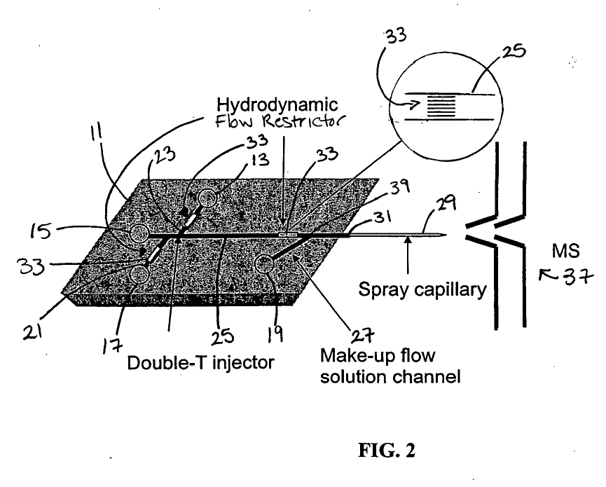

FIG. 2 shows an embodiment wherein additional hydrodynamic flow restrictors 33 are placed in various channels 21, 23 of the microfluidic device 11. As shown, a hydrodynamic flow restrictor 33 is placed in the input channel 21. Further, a hydrodynamic flow restrictor 33 is placed in the waste channel 23. Hydrodynamic flow restrictors 33 positioned in various channels 21, 23 may function as filters or may serve to prevent fluid from flowing from the main channel 25 back into the input reservoir 17 or from the waste reservoir back into the main channel 25. Those skilled in the art will recognize that hydrodynamic flow restrictors placed in any of the various channels of the present invention is still within the spirit and scope of the present invention.

In an embodiment, the main channel 25 of the microfluidic device 11 comprises a coating. In an embodiment, the coating is uncharged. A common problem with microfluidic devices is that the various channels of the device require a charge in order to utilize electroosmotic flow. As such, charged analytes are attracted to the charged walls of the various channels leading to sample loss. In an embodiment, the main channel 25 of the microfluidic device 11 may be coated with an uncharged coating to prevent such sample loss.

In an embodiment, the coating comprises polyethylene glycol. In an embodiment, the main channel 25 is constructed of an uncharged material. Those skilled in the art will recognize that various coatings are within the spirit and scope of the present invention.

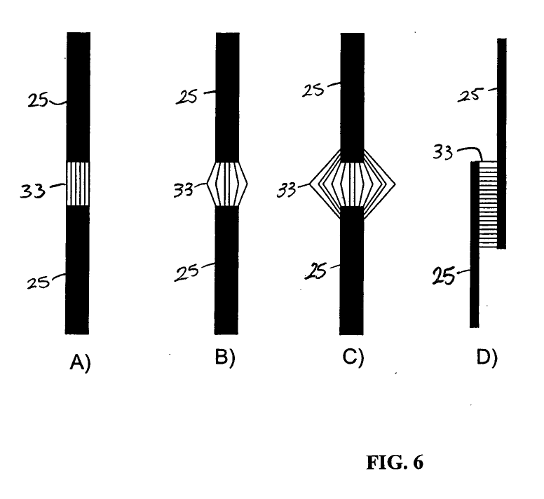

FIGS. 6A-D show various embodiments of the hydrodynamic flow restrictor 33 of the present invention. FIG. 6A shows an embodiment wherein a series of deep, narrow channels connect a first segment of the main channel 25 to a second segment of the main channel 25. FIG. 6B shows an embodiment wherein the hydrodynamic flow restrictor 33 comprises narrow, deep channels with increased island width. FIG. 6C shows an embodiment wherein a hydrodynamic flow restrictor 33 comprises a plurality of small channels extending from the end and the sides of the main channel. FIG. 6D shows an embodiment wherein a hydrodynamic flow restrictor 33 embodiment is used to increase a number of connecting channels while keeping a uniform flow path from one large channel to the connected second large channel. Those skilled in the art will recognize that various hydrodynamic flow restrictor configurations are within the spirit and scope of the present invention.

### EXPERIMENTAL

Abstract

A hydrodynamic flow restrictor (HDR) has been fabricated in a microfluidic channel by laser micromachining that is used to combine electrokinetic and hydrodynamic flow streams. Combining electrokinetic and hydrodynamic flow streams is challenging in microfluidic devices because the hydrodynamic flow often overpowers the electrokinetic flow, making it more difficult to use low electroosmotic flow in the electrokinetic portion of the system. The HDR has been incorporated into a capillary electrophoresis-mass spectrometry interface that provides continuous introduction of a make-up solution and negates the hydrodynamic backpressure in the main channel to the extent that low EOF can be utilized. Moreover, the hydrodynamic backpressure is sufficiently minimized to allow coatings that minimize EOF to be used in the electrokinetically driven channel. Such coatings are of great importance for the analysis of proteins and other biomolecules that adsorb to charged surfaces.

### INTRODUCTION

In this experiment, a laser micromachined hydrodynamic flow restrictor is used to combine electrokinetic and hydrodynamic flow streams continuously. The HDR resists hydrodynamic flow because the linear velocity of the hydrodynamic flow is dependent on the width of the channel squared, while the electrokinetic flow is largely independent of the channel width. Laser micromachining is used to fabricate high aspect ratio channels for the HDR whose width is less than their depth. The channel profile and increased density of parallel HDR channels reduces Joule heating and improves resistance to hydrodynamic flow. These characteristics allow the HDR to be placed directly in the electrophoretic separation without excessive Joule heating.

In this experiment, the HDR is utilized in a CE/ESI-MS interface, making it possible to increase the flowrate at the spray tip with a make-up solution under low EOF conditions. The improved performance with low EOF permits the use of PEG coatings that minimize protein adsorption and EOF. The addition of the make-up solution provides easy adjustment of the flow at the ESI tip, which is critical because the separation and ESI voltages are applied by the same electrode, preventing independent adjustment. For the ESI interface, the HDR is required to prevent back-flow of hydrodynamically introduced make-up solution into the separation channel, because the frictional resistance to flow through the ESI tip is significant. Additionally, introduction of the make-up solution can be used to adjust the solvent composition and pH, for independent pH optimization for the separation and electrospray. The performance of the ESI interface for introduction of analyte bands into the MS was characterized, and it was found to produce stable spray and contribute minimally to band broadening.

Materials and Reagents

Bodipy FL succinimidyl ester and rhodamine B were purchased from Molecular Probes (Eugene, Oreg.). Ammonium acetate was obtained from Sigma (St. Louis, Mo.). Distilled de-ionized water (18 MΩ) was produced with a Barnstead nanopure infinity system (Dubuque, Iowa). Methacryloxypropyltrimethoxysilane (MPTMS) and N-(triethoxysilylpropyl)-O-polyethyleenoxide urethane (TESP) were purchased from Gelest (Morrisville, Pa.). Irgacure 1800 (photoinitiator) was obtained from Ciba (Tarrytown, N.Y.). Fused silica capillaries were purchased from Polymicro Technologies (Phoenix, Ariz.). Soda lime glass slides were purchased from Telic (Santa Monica, Calif.).

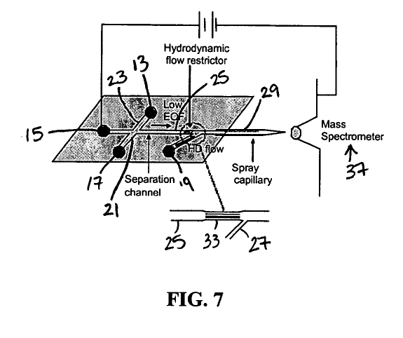

The microfluidic devices were fabricated using standard photolithography and wet chemical etching techniques as previously described. Briefly, 80 μm wide (width at half height) and 25 μm deep separation and side channels were patterned of soda lime glass using a photomask with patterns created with Freehand 10 software and etched using hydrofluoric acid. All microfluidic channel measurements were obtained using a stylus profiler with a 2 μm, 60° angle tip, (Tencor Instruments, San Jose, Calif.). Access holes were created on the etched microchip using a microdrill. A hydrodynamic flow restrictor of the make-up solution in the main channel was fabricated using an MP 100 UV laser micromachining system (Oxford Lasers, Oxfordshire, UK). Six parallel 10 μm channels were etched on the glass substrate, connecting the main channel and the intersection of the main channel and the make-up solution channel as shown in FIG. 7. The cover glass was bonded by low temperature and high temperature bonding of the etched and drilled glass plate using a blank soda lime glass cover plate. A low dead volume connection of the spray tip to the microchip was achieved by drilling a 360 μm diameter hole through the junction between the bonded cover plate and etched glass plate (using a technique developed by Bing et al., J. Analytical Chemistry 1999, 71, 3292-3296)). The ESI spray tips were pulled in-house with a laser puller (P-2000, Sutter Instrument Co., Novato, Calif.) and had the following dimensions: 2 cm in length, 50 μm ID, 360 μm fused silica capillary with a 20 μm tip. Once prepared, an ESI tip was inserted into the 360 μm hole in the microfluidic chip by press fitting it manually. Initial attempts to fabricate a hydrodynamic flow restrictor (HDR) involved the in situ polymerization of a small plug (less than about 0.5 cm in length) of polymer monolith. Methacryloxypropyltrimethoxysilane (MPTMS) was reacted with 1M HCl, toluene and Irgacure 1800 (photoinitiator). The channel was filled with the polymer solution and UV light at 365 nm was illuminated at the location of the flow restrictor for about 10 minutes after the unpolymerized solution was rinsed out of the channel. The whole chip was masked leaving only a 3 mm portion of the separation channel exposed to the UV light.

The channel surfaces were modified with a polyethylene glycol terminated silane self assembled monolayer (SAM). The PEG-silane solution was prepared from N-(triethoxysilylpropyl)-O-polyethyleneoxide urethane (TESP) as reported by Cox et al., Biomaterials, 2002, 23, 929-935. The channels were rinsed with sodium hydroxide, deionized water and methanol, with each solution delivered for about 5 minutes. The PEG-silane solution was then pumped through the channels for about 6 hours, after which the coating was cured at about 60° C. in the oven for about 2 hours. The channels were then conditioned with the corresponding run buffer.

Fluorescence Imaging and Voltage Control

Fluorescence imaging experiments were performed using a Nikon inverted fluorescence microscope. A 4× microscope objective was used to focus the excitation beam and to collect the fluorescent light, which was passed through a 530±30 nm emission band pass filter. A Roper CCD camera (Roper Scientific, Tucson Ariz.) controlled by Metamorph software (Universal Imaging Corporation, Downingtown, Pa.) was used to capture images. A voltage of 4 kV was applied to reservoir 3 (as shown in FIG. 7) containing a solution of about 60 μM bodipy FL, SE in about 20 mM ammonium acetate buffer (pH 8) containing about 50% methanol. Rhodamine B in 0.1M acetic acid was introduced hydrodynamically through the side channels at flowrates beginning at about 50 nL/min and increased to about 500 nL/min in approximately 50 nl/min increments.

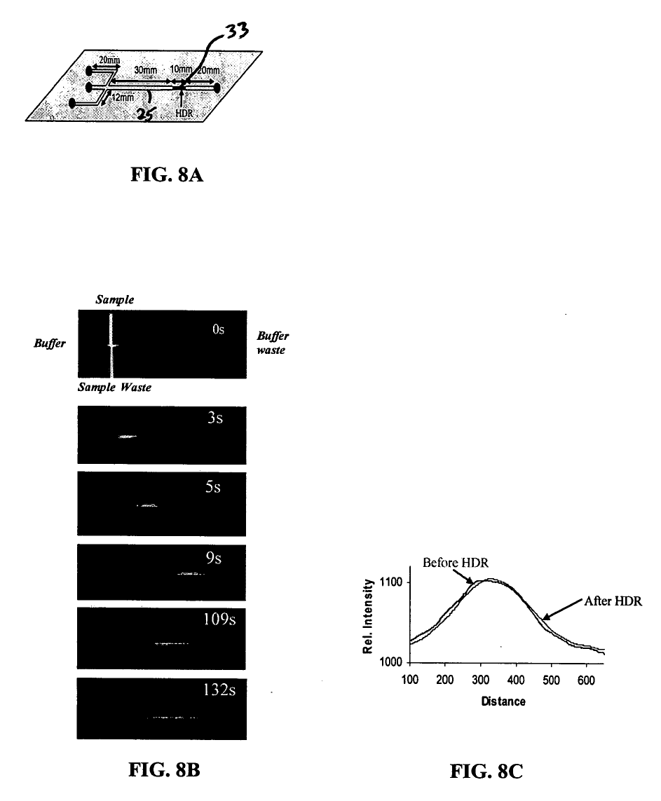

A microfluidic device with the channel design shown in FIG. 8A was used to determine the band broadening due to the HDR. A sample plug of 1 μM rhodamine B in 20 mM ammonium acetate at pH 8 was loaded by applying a voltage of about 4.5 kV, about 4.2 kV, about 3.7 kV, and ground to the sample, buffer, buffer waste, and sample waste reservoirs respectively. The sample was injected into the separation channel by applying a voltage of about 4.2 kV to the buffer reservoir with the other electrodes at ground. The sample plug profiles of rhodamine B in about 20 mM ammonium acetate at pH 8 were recorded before and after the restrictor to determine the extent to which band broadening increases due to the presence of the HDR.

Chip/ESI-MS

The microfluidic device was interfaced to a LCQ Deca XP ion trap mass spectrometer (Thermo Electron Corporation, Waltham, Mass.). The channels were modified by treating the channels with a PEG-silane coating; the coating reduced EOF by about 75%. The coating channels were then filled with a running buffer. The reservoirs were loaded with the buffers ensuring that there were no bubbles in the system. To determine the stability of the electrospray, reservoir 1-3 were filled with the electrophoretic buffer, 20 nM ammonium acetate in water/methanol (80/20% v/v) was hydrodynamically introduced via reservoir 19. The chip on a X,Y,Z translational stage was placed in front of the mass spectrometer with a distance of 3-5 mm between the mass spectrometer orifice and spray tip.

Results and Discussion

A hydrodynamic flow restrictor was fabricated within the separation channel as shown in FIG. 7, to prevent backflow in the separation channel. Initial attempts to achieve hydrodynamic flow restriction involved the in situ polymerization of a small plug of polymer solution. The resulting polymer monolith provided resistance to hydrodynamic flow because of its small pores that act like numerous small channels in parallel. However, the polymer monolith results in too large a backpressure in the separation channel, which makes it difficult to fill the channels. Moreover, the glass surface of the microchannel and the polymer monolith region exhibit different electroosmotic flow properties which complicates the flow through the electrophoretic channels of the device. In addition, because of the hydrophobicity of the polymer monolity, at least about 50% organic was required in the electrophoretic buffer to elute protein adsorbed on the monolith and polymer leachates from the synthesis introduced more background noise in the MS signal. The use of the laser micromachined HDR prevents the generation of surfaces with chemistries that are substantially different from standard microfluidic channels.

For use in a CE/MS interface, a critical aspect with the interface is the band broadening introduced by the HDR. Several factors contribute to band broadening in electrophoretic separations on microfluidic platforms, including axial diffusion, Joule heating, channel geometry, injection plug length, and the detector path length. Adsorption of sample to the channel wall also contributes to band broadening especially for biologically samples such as proteins and peptides. To determine the band broadening introduced by the HDR, a chip utilizing the flow restrictor and a second chip without the flow restrictor serving as a control (design shown in FIG. 8A) were fabricated. In FIG. 8B, images of a 1 μM rhodamine B sample plug are shown before and after the HDR. The CCD images show the increase in the sample band width as it migrates down the separation channel, from the time the sample plug was injected. There is very minimal band broadening after the sample plug has passed through the restrictor, which was calculated to be a 2% increase in peak width of the sample band. Therefore, the HDR can be used to combine an electrokinetically driven system with a hydrodynamically driven system. In the case of upstream separations, the HDR contributes a negligible amount to band broadening.

More specifically, FIG. 8A is a schematic diagram of the microfluidic device used for band broadening studies. FIG. 8B shows CCD camera images of a 1 μM rhodamine B sample plug from the time the plug was injected and at different points along the separation channels. FIG. 8C shows a corresponding graph which shows band profiles of a sample plug before the HDR (about 109 seconds after injection), and after the HDR (about 132 seconds after injection). The data clearly demonstrates that the contribution of the flow restrictor to band broadening is minimal. The center of the sample bands obtained before and after the HDR are about 27 mm and about 43 mm from the injection cross respectively.

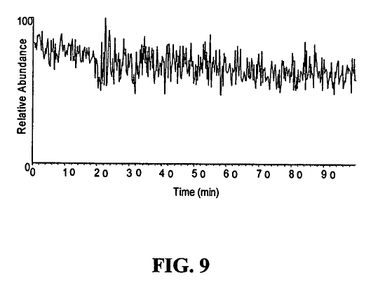

The make-up solution is used to adjust the flow rate at the ESI tip to optimize the stability of the electrospray. The minimal make-up solution flowrate found to stabilize electrospray is about 100 nL/min. This flowrate is determined over about a 100 minute period by recording the spectra of the background buffer ions with the microfluidic chip spraying into the MS. The total ion chromatogram, shown in FIG. 9, is representative of the background stability (RSD 14.1%) achieved with this device. FIG. 9 shows the stability of the electrospray with a total ion chromatogram of the solvent/buffer background. The electrophoretic buffer used was about 20 mM acetate in water/methanol (80/20% v/v) and the make-up solution was 0.1M acetic acid in water/methanol (80/20% v/v) delivered at about 100 nL/min. Reported literature RSD values for signal intensities in nanoESI have ranged between about 5-21% depending on experimental conditions such as the dimensions and quality of spray emitter as well as the number of spectra averaged. With this sheathless configuration, the potential that generates the EOF and supplies the ESI voltage is provided by the electrode at the channel inlet. The required flowrate is primarily determined by the orifice and ID of the spray tip and ESI voltage. Because the EOF and the ESI voltage are coupled and cannot be adjusted independently, the make-up flow provides a means to optimize the flowrate, increasing the stability of the electrospray. The stability of the electrospray can further be improved by introducing independent control of the CE and ESI voltages which is currently being integrated onto the device.

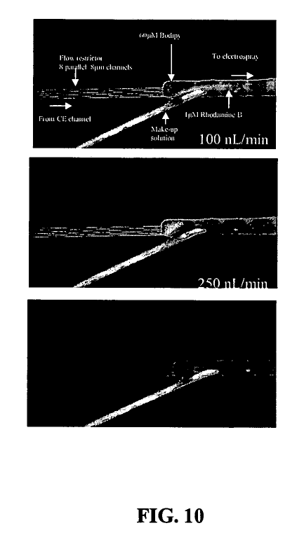

The performance of the HDR in resisting hydrodynamic flow is characterized by introducing the make-up solution at different flow rates, and observing the flowrate at which the make-up solution is forced into the narrow HDR channels. In order to image the flow profile, a bodipy solution is introduced electrokinerically from reservoir 15, and a rhodamine solution is introduced hydrodynamically through the make-up solution channel. The convergence of the bodipy solution carried by electroosmotic flow and the rhodamine B solution introduced hydrodynamically through the make-up solution channel is shown in FIG. 10. FIG. 10 shows the convergence and mixing of the electrokinetically driven flow through the separation channel and the hydrodynamically driven make-up solution. The Bodipy FL, SE (green dye) is mobilized electrokinetically using a high voltage of about 4 kV at reservoir 17 and the Rhodamine B (red dye) is mobilized hydrodynamically using a syringe pump. This configuration allows the two dyes to be mixed without the Rhodamine solution flowing upstream of the microfluidic channel due to frictional resistance of the small parallel channels to hydrodynamic flow. The images of FIG. 10 correspond to the flow profiles observed at make-up flow rates of about 100, about 250 and about 300 nL/min. At about 300 nL/min, the HDR does not provide adequate resistance to flow and the make-up solution prevents elution of the Bodipy.

As shown in FIG. 10, as the make-up solution flowrate is increased from about 50 nL/min, there is no backflow into the HDR channels up to about 250 nL/min, but backflow of the make-up solution in HDR channels was evident at about 300 nL/min. Therefore, the optimum make-up flow rate required by the ESI interface at about 100 nL/min. The velocity of the electroosmotic flow in the separation channel using bodipy as the neutral marker is measured to be about 0.5±0.1 mm/s (60 nL/min volumetric flowrate) at a field strength of about 470 V/cm. Chip-ESI-MS interfaces in literature employ much higher electroosmotic velocities in the separation channel. In one case, using a glass chip with an unmodified surface, the EOF velocity is measured to be about 2 mm/s (240 nL/min) in 10 mM sodium borate (pH 9.6) and about 0.5 mm/s in 10 mM ammonium acetate at a field strength of about 550 V/cm. These velocities are at least an order of magnitude greater than the EOF velocity used in this experiment.

In summary, the hydrodynamic flow restrictor (HDR) can be used to effectively introduce make-up flow solution on microfluidic platforms operating under low EOF conditions while maintaining stable electrospray. The make-up flow can be used to optimize the solution flowrate at the ESI interface, and to adjust the composition of the solution. The contribution of the HDR to band broadening in the separation channel has also been demonstrated to be minimal.

All patents, patent applications, and published references cited herein are hereby incorporated by reference in their entirety. While this invention has been particularly shown and described with references to preferred embodiments thereof, it will be understood by those skilled in the art that various changes in form and details may be made therein without departing from the scope of the invention encompassed by the appended claims.

What is claimed is:

1. A microfluidic device comprising:
a substrate having an input channel and an output channel;
a main channel engaging the input channel to the output channel;
a hydrodynamic flow restrictor positioned in the main channel; and
a make-up flow channel engaging the main channel at a position between the hydrodynamic flow restrictor and the output channel, wherein
the hydrodynamic flow restrictor substantially prevents the make-up flow solution from traveling towards the input channel of the microfluidic device.

2. The device of claim 1 further comprising a spray capillary engaging the output channel.

3. The device of claim 1 further comprising a mass spectrometer in communication with the spray capillary.

4. The device of claim 1 wherein the main channel is treated with a coating.

5. The device of claim 4 wherein the coating comprises polyethylene glycol.

6. The device of claim 1 wherein the hydrodynamic flow restrictor is a frit.

7. The device of claim 1 wherein the hydrodynamic flow restrictor is a weir.

8. The device of claim 1 wherein the hydrodynamic flow restrictor is a plurality of narrow, deep channels etched into the main channel via laser etching.

9. The device of claim 8 wherein the plurality of the narrow, deep channels has a cross-sectional area approximately equal to a cross-sectional area of the main channel.

10. A microfluidic device capable of utilizing hydrodynamic flow and electroosmotic flow in order to deliver a sample to a mass spectrometer comprising:
a substrate having an input channel and an output channel;
a main channel capable of maintaining low electroosmotic flow engaging the input channel to the output channel;
a hydrodynamic flow restrictor positioned in the main channel; and
a make-up flow channel engaging the main channel at a position between the hydrodynamic flow restrictor and the output channel wherein a make-up solution is delivered to the main channel from the make-up flow channel by a hydrodynamic flow.

11. The device of claim 10 further comprising a spray capillary engaging the output channel.

12. The device of claim 10 wherein the main channel is coated with polyethylene glycol.

13. The device of claim 10 wherein the hydrodynamic flow restrictor is a frit.

14. The device of claim 10 wherein the hydrodynamic flow restrictor is a weir.

15. The device of claim 10 wherein the hydrodynamic flow restrictor is a plurality of narrow, deep channels etched into the main channel via laser etching.

16. The device of claim 15 wherein the plurality of the narrow, deep channels has a cross-sectional area approximately equal to a cross-sectional area of the main channel.

17. The device of claim 10 wherein the hydrodynamic flow restrictor comprises a sol gel material.

18. A method for utilizing a hydrodynamic flow in conjunction with an electroosmotic flow in order to deliver a sample to a mass spectrometer, comprising:
providing a substrate having an input channel and an output channel, wherein a main channel engages the input channel to the output channel;
delivering a sample to the input channel wherein a low electoosmotic force drives the sample through the main channel and towards the output channel;
positioning a hydrodynamic flow restrictor in the main channel; and
delivering a make-up solution via hydrodynamic flow to the main channel at a position between the hydrodynamic flow restrictor and the output channel, wherein
the hydrodynamic flow restrictor substantially negates a hydrodynamic backpressure in the main channel to the extent that low electroosmotic flow may be utilized in the main channel.

19. The method of claim 18 wherein the hydrodynamic flow restrictor is a plurality of narrow, deep channels etched into the main channel via laser etching.

20. The method of claim 19 wherein the plurality of the narrow, deep channels has a cross-sectional area approximately equal to a cross-sectional area of the main channel.
